(19) United States
(12) Patent Application Publication
(10) Pub. No.: US 2003/0208610 A1
(43) Pub. Date: Nov. 6, 2003

(54) Method and apparatus for facilitating content distribution across a network

(76) Inventors: Robert J. Rochetti, Los Altos Hills, CA (US); Hideya Kawahara, Mountain View, CA (US)

Correspondence Address: PARK, VAUGHAN & FLEMING LLP, 508 SECOND STREET, SUITE 201, DAVIS, CA, 95616, US

(21) Appl. No.: 10/138,149

(22) Filed: May 1, 2002

(51) Int. Cl. G06F 15/16

(52) U.S. Cl. 709/230; 709/219

(57) ABSTRACT

One embodiment of the present invention provides a system that distributes content across a network using a specialized protocol based on an operating environment. During operation, the system receives a request at a local node for content from a remote node via a generic protocol. The system also receives a specifier for a set of capabilities of the local node as well as a specifier for a set of capabilities of the remote node. Additionally, the system determines the specialized protocol over which to distribute the content to the remote node based on the operating environment. This operating environment can include, the set of capabilities of the local node, the set of capabilities of the remote node, and the capability of the network. Finally, the system distributes the content to the remote node via the specialized protocol. The specialized protocol can take into account the capabilities of the network, the local node, and the remote node, thereby allowing for more optimal distribution of the content.

### BACKGROUND

1. Field of the Invention

The present invention relates to computer networks. More specifically, the present invention relates to a method and an apparatus for facilitating content distribution across a computer network.

2. Related Art

The explosive growth of the Internet has brought about many changes in the way in which computers are used. Computers have traditionally been used for business and scientific purposes, such as solving complex mathematical problems and performing statistical analysis, and for personal use, including keeping track of finances and gaming. In recent times, however, computers have become hubs for the delivery of multimedia content. In some cases, computers have replaced television sets and radios.

In recent years, network bandwidth has improved exponentially, and new technologies have entered the market. In addition to the growing number of wired network technologies, numerous wireless technologies, including 802.11x, Bluetooth®, and the various PCS protocols, are rapidly becoming a staple of networking infrastructure. These new technologies have also brought handheld computers, cell phones, game consoles, and PDAs into the networked multimedia arena. Virtually all electronic devices capable of handling content are being networked.

One problem that exists, however, is that most of the media players and file formats have been generalized to allow for use on the widest possible assortment of devices. These devices can differ significantly in a number of ways. For example, devices can differ in bandwidth, latency, connection establishment method, error recovery method, communications protocols, amount of memory, and processing power. This “least common denominator” approach has resulted in the use of file formats and media players that are not optimized for computing devices and their network connections.

Another problem exists with communications protocols. Different types of content have different requirements for their proper use. Some require vast amounts of bandwidth, while others require very little. Some utilize compression, while others do not. Using a one-size-fits-all protocol is typically not optimal for different types of content and, in many cases, will not work.

What is needed is a method and apparatus that facilitates content distribution across a network in a manner that is tailored for specific devices, content to be delivered, and network connections.

### SUMMARY

One embodiment of the present invention provides a system and a means for distributing content across a network using a specialized protocol based on an operating environment. During operation, the system receives a request at a local node for content from a remote node via a generic protocol. The system also receives a specifier for a set of capabilities of the local node as well as a specifier for a set of capabilities of the remote node. Additionally, the system determines the specialized protocol over which to distribute the content to the remote node based on the operating environment. This operating environment can include, the set of capabilities of the local node, the set of capabilities of the remote node, and the capability of the network. Finally, the system distributes the content to the remote node via the specialized protocol. The specialized protocol can take into account the capabilities of the network, the local node, and the remote node, thereby allowing for more optimal distribution of the content.

In a variation on this embodiment, determining the specialized protocol additionally involves considering a characteristic of the content. The characteristic of the content can include one of: an acceptable compression degradation factor; an acceptable number of lost frames; or an acceptable level of encryption.

In a variation on this embodiment, the system determines the format of the content to distribute to the remote node based on the operating environment.

In a variation on this embodiment, the system determines the capabilities of the network prior to determining the specialized protocol.

In a variation on this embodiment, determining the specialized protocol involves negotiating with the remote node.

In a variation on this embodiment, the system sends a protocol handler for the specialized protocol to the remote node, which enables the remote node to use the specialized protocol. In a further variation, the system constructs the protocol handler for the specialized protocol and then sends the protocol handler to the remote node.

In a variation on this embodiment, the system additionally sends a content handler to the remote node. This content handler facilitates performing operations on the content. In a further variation, the content handler is a media player for the content.

In a variation on this embodiment, the specialized protocol can specify a form of encryption or a type of compression for the content.

In a variation on this embodiment, the specifier for the set of capabilities can include, an amount of memory, a type of memory, an amount of processors, a type of processor, a sound capability, and a graphics capability.

### BRIEF DESCRIPTION OF THE FIGURES

FIG. 1 illustrates a computer network in accordance with an embodiment of the present invention.

FIG. 2 illustrates the operating environment for the content distribution in accordance with an embodiment of the present invention.

FIG. 3 illustrates the process of distributing content in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer Network

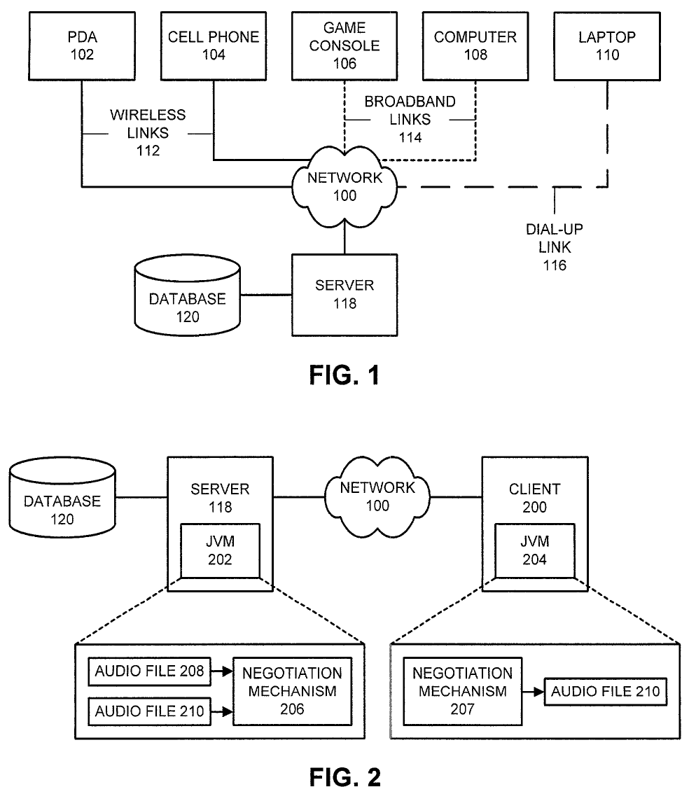

FIG. 1 illustrates a computer network 100 in accordance with an embodiment of the present invention. As is illustrated in FIG. 1, Personal Digital Assistant (PDA) 102 and cell phone 104 are coupled to network 100 via wireless links 112. Network 100 can generally include any type of wire or wireless communication channel capable of coupling together computing nodes. This includes, but is not limited to, a local area network, a wide area network, or a combination of networks. In one embodiment of the present invention, network 100 includes the Internet. Wireless links 112 can include any type of wireless network. This includes, but is not limited to, 802.11x, Bluetooth®, Code Division Multiple Access (CDMA), Time Division Multiple Access (TDMA), and infrared. Game console 106 and computer 108 are coupled to network 100 via broadband links 114 and laptop 110 is coupled to network 100 via dial-up link 116.

Server 118 is also coupled to network 100. Server 118 can generally include any computational node including a mechanism for servicing requests from a client for computational and/or data storage resources.

Server 118 is also coupled to database 120. Database 120 can generally include any type of system for storing data in non-volatile storage. This includes, but is not limited to, systems based upon magnetic, optical, and magneto-optical storage devices, as well as storage devices based on flash memory and/or battery-backed up memory.

Content Distribution

FIG. 2 illustrates the operating environment for the content distribution process in accordance with an embodiment of the present invention. As is illustrated in FIG. 2, server 118 includes Java Virtual Machine (JVM) 202. The terms JAVA, JVM and JAVA VIRTUAL MACHINE are trademarks of SUN Microsystems, Inc. of Palo Alto, Calif.

Client 200 also includes a JVM 204. Note that client 200 can include any one of, PDA 102, cell phone 104, game console 106, computer 108, or laptop 110 illustrated in FIG. 1. Client 200 can generally include any node on a network including computational capability and including a mechanism for communicating across the network. Moreover, note that any platform-independent virtual machine could be used in place of JVM 202 or JVM 204.

Server 118 contains audio file 208 and audio file 210. Audio files 208 and 210 represent the same audio data in different file formats. Server 118 and client 200 negotiate which network protocol to use and which audio format to use via negotiation mechanism 206 within JVM 202 and negotiation method 207 within JVM 204. Note that negotiation mechanism 206 and negotiation mechanism 207 can be instances of the same type of negotiation mechanism.

Process of Content Distribution

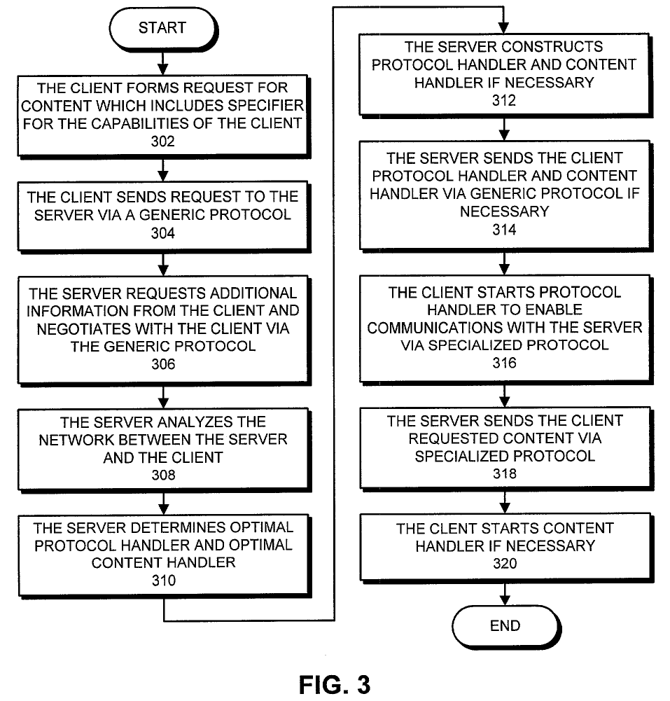

FIG. 3 illustrates the process of distributing content in accordance with an embodiment of the present invention. This process uses a mechanism for identifying and deploying content, as well as an optimal protocol handler for transmitting and sharing content based on the characteristics of the operating environment under which the distribution and the execution of the content takes place. These characteristics include, but are not limited to, the capability of the hosting machine, the capability of the requesting machine, the capability of the network pathway between the hosting machine and the requesting machine, the type of content, and the context under which the content distribution happens.

One embodiment of the present invention uses a two-phase bootstrapping protocol. In the first phase, the requesting machine, client 200, forms a request for content (step 302). This request includes a specifier for the capabilities of client 200, which can include, CPU power, amount of memory, and graphics capability and sound capability. Next, client 200 sends the request to the hosting machine, server 118, via a generic protocol (step 304).

Server 118 then asks client 200 for additional information which can include, preferred compression algorithm, caching strategy, error recovery strategy, and encryption algorithm. Server 118 also negotiates with client 200 if necessary (step 306). This negotiation might involve, for example, determining the number of CPU cycles client 200 will spare for handling content.

In one embodiment of the present invention, server 118 analyzes the capability of network 100 based on the time it takes for the responses to reach server 118 from client 200 (step 308). In some cases, this analysis might also involve asking a machine that manages network traffic on network 100 for more information regarding the traffic.

Server 118 may also identify characteristics of the requested content including the type of content, size, and typical bandwidth required to deliver the content at execution speed.

Additionally, server 118 may obtain information about the context of the request. For example, if the request is issued in the context of an encrypted chat, the context may include the chat group ID, the IP address of the chat server, and an encryption key for secure communication.

Based on all of the information gathered by server 118, server 118 identifies the optimal protocol handler and optimal content handler for the request (step 310). Additionally, server 118 identifies all of the optimal parameters for the handlers. In one instance of the present invention, server 118 may use a table based on heuristics to determine the optimal handlers and parameters. Moreover, server 118 can construct the handlers on the fly if necessary (step 312).

These handlers are typically written in a platform-independent language such as the JAVA programming language. If this is not the case, server 118 can obtain the information regarding the requestor's hardware architecture, and choose the protocol handler that best suits the hardware architecture. Server 118 then sends the protocol handler and the content handler to client 200 via the generic protocol (step 314).

In the second phase, client 200 starts the execution of the protocol handler to enable communications via the specialized protocol with server 118 (step 316). Server 118 then sends the content to client 200 via the specialized protocol (step 318).

If necessary, client 200 starts the execution of the content handler to facilitate the execution or displaying of the content (step 320). In one embodiment of the present invention, the content handler is a media player that receives streaming media files via the specialized protocol and displays the media files on a display device.

With the aforementioned differences between computing devices and the networks that couple them, these content handlers and protocol handlers facilitate the optimal distribution and use of content across various networks and computing platforms. For a network with extremely high bandwidth, the present invention might provide a protocol handler that facilitates the distribution of a high quality version of a media file with a large file size and no file compression. For a PDA that is connected to a low-bandwidth wireless network, the present invention might provide a low-quality version of the same media file with a relatively small file size and high compression. The system can also send a content handler to the remote node that is capable of uncompressing the media file and displaying it to an end user.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for distributing content across a network using a specialized protocol based on an operating environment, comprising:
receiving a request for content from a remote node via a generic protocol at a local node;
receiving a specifier for a set of capabilities of the remote node;
determining the specialized protocol over which to distribute the content to the remote node based on the operating environment, wherein the operating environment can include, the set of capabilities of the local node, the set of capabilities of the remote node, and the capability of the network coupling the local node and the remote node; and
distributing the content to the remote node via the specialized protocol.

2. The method of claim 1, wherein determining the specialized protocol additionally involves considering a characteristic of the content, wherein the characteristic can include one of:
an acceptable compression degradation factor;
an acceptable number of lost frames; and
an acceptable level of encryption.

3. The method of claim 1, further comprising determining a format of the content to distribute to the remote node based on the operating environment.

4. The method of claim 1, wherein prior to determining the specialized protocol, the method additionally involves determining the capability of the network.

5. The method of claim 1, wherein determining the specialized protocol involves negotiating with the remote node.

6. The method of claim 1, further comprising sending the remote node a protocol handler for the specialized protocol so that the remote node can use the protocol handler to communicate with the local node.

7. The method of claim 6, wherein prior to sending the protocol handler to the remote node, the method additionally involves constructing the protocol handler.

8. The method of claim 1, further comprising sending to the remote node a content handler for performing operations on the content.

9. The method of claim 8, wherein the content handler is a media player for the content.

10. The method of claim 1, wherein the specialized protocol can specify a form of encryption or a type of compression for the content.

11. The method of claim 1, wherein the specifier for the set of capabilities can include, an amount of memory, a type of memory, a number of processors, a type of processor, a sound capability, and a graphics capability.

12. A computer-readable storage medium storing instructions that when executed by a computer cause the computer to perform a method for distributing content across a network using a specialized protocol based on an operating environment, comprising:
receiving a request for content from a remote node via a generic protocol at a local node;
receiving a specifier for a set of capabilities of the remote node;
determining the specialized protocol over which to distribute the content to the remote node based on the operating environment, wherein the operating environment can include the set of capabilities of the local node, the set of capabilities of the remote node, and the capability of the network coupling the local node and the remote node; and
distributing the content to the remote node via the specialized protocol.

13. The computer-readable storage medium of claim 12, wherein determining the specialized protocol additionally involves considering a characteristic of the content, wherein the characteristic can include one of:
an acceptable compression degradation factor;
an acceptable number of lost frames; and
an acceptable level of encryption.

14. The computer-readable storage medium of claim 12, further comprising determining a format of the content to distribute to the remote node based on the operating environment.

15. The computer-readable storage medium of claim 12, wherein prior to determining the specialized protocol, the method additionally involves determining the capability of the network.

16. The computer-readable storage medium of claim 12, wherein determining the specialized protocol involves negotiating with the remote node.

17. The computer-readable storage medium of claim 12, further comprising sending the remote node a protocol handler for the specialized protocol so that the remote node can use the protocol handler to communicate with the local node.

18. The computer-readable storage medium of claim 17, wherein prior to sending the protocol handler to the remote node, the method additionally involves constructing the protocol handler.

19. The computer-readable storage medium of claim 12, further comprising sending to the remote node a content handler for performing operations on the content.

20. The computer-readable storage medium of claim 19, wherein the content handler is a media player for the content.

21. The computer-readable storage medium of claim 12, wherein the specialized protocol can specify a form of encryption or a type of compression for the content.

22. The computer-readable storage medium of claim 12, wherein the specifier for the set of capabilities can include, an amount of memory, a type of memory, a number of processors, a type of processor, a sound capability, and a graphics capability.

23. An apparatus that distributes content across a network using a specialized protocol based on an operating environment, comprising:
a communications configured to receive a request for content from a remote node via a generic protocol mechanism at a local node;
a receiving mechanism configured to receive a specifier for a set of capabilities of the remote node;
a determination mechanism configured to determine the specialized protocol over which to distribute the content to the remote node based on the operating environment, wherein the operating environment can include, the capabilities of the local node, the capabilities of the remote node, and the capability of the network coupling the local node and the remote node; and
a content distribution mechanism configured to distribute the content to the remote node via the specialized protocol.

24. The apparatus of claim 23, wherein the determination mechanism is additionally configured to consider a characteristic of the content, wherein the characteristic can include one of:
an acceptable compression degradation factor;
an acceptable number of lost frames; and
an acceptable level of encryption.

25. The apparatus of claim 23, wherein the determination mechanism is further configured to determine a format of the content to distribute to the remote node based on the operating environment.

26. The apparatus of claim 23, wherein the determination mechanism is further configured to determine the capability of the network.

27. The apparatus of claim 23, wherein the determination mechanism is further configured to negotiate with the remote node.

28. The apparatus of claim 23, wherein the distribution mechanism is further configured to send the remote node a protocol handler for the specialized protocol so that the remote node can use the protocol handler to communicate with the local node.

29. The apparatus of claim 28, further comprising a construction mechanism configured to construct the protocol handler.

30. The apparatus of claim 23, wherein the distribution mechanism is further configured to send to the remote node a content handler for performing operations on the content.

31. The apparatus of claim 30, wherein the content handler is a media player for the content.

32. The apparatus of claim 23, wherein the specialized protocol can specify a form of encryption or a type of compression for the content.

33. The apparatus of claim 23, wherein the specifier for the set of capabilities can include, an amount of memory, a type of memory, a number of processors, a type of processor, a sound capability, and a graphics capability.

34. A means for distributing content across a network using a specialized protocol based on an operating environment, comprising:
a receiving means for receiving a request for content from a remote node via a generic protocol at a local node;
wherein the receiving means additionally receives a specifier for a set of capabilities of the remote node;
a determining means for determining a specialized protocol over which to distribute the content to the remote node based on an operating environment, wherein the operating environment can include, the set of capabilities of the local node, the set of capabilities of the remote node, and the capability of the network coupling the local node and the remote node; and
a distribution means for distributing the content to the remote node via the specialized protocol.
